(19) United States
(12) Patent Application Publication
(10) Pub. No.: US 2025/0102393 A1
(43) Pub. Date: Mar. 27, 2025

(54) DETECTION SYSTEM, ASSEMBLY, AND METHOD

(71) Applicant: Charm Sciences, Inc., Lawrence, MA (US)

(72) Inventor: Richard Skiffington, North Reading, MA (US)

(73) Assignee: Charm Sciences, Inc., Lawrence, MA (US)

(21) Appl. No.: 18/730,868

(22) PCT Filed: Jan. 19, 2023
(86) PCT No.: PCT/US2023/011104

§ 371 Date: Jul. 22, 2024

Related U.S. Application Data
(60) Provisional application No. 63/302,232, filed on Jan. 24, 2022.

(51) Int. Cl. G01M 3/26; F25B 49/02; G01F 1/66

(52) U.S. Cl. CPC G01M 3/26; F25B 49/02; G01F 1/662; F25B 2700/04

(57) ABSTRACT

A leak detection system and assembly. In one embodiment, a refrigeration system includes a non-invasive ultrasonic flowmeter to monitor an ultrasonic signal. The result is a refrigeration system to trigger a leak detection alert.

This application claims the benefit of PCT/2023/011104, filed Jan. 19, 2023, which claims the benefit of U.S. provisional application No. 63/302,232, filed Jan. 24, 2022, all of which are incorporated herein by reference in their entireties.

### FIELD

The present disclosure relates generally to detection and, more particularly, to a refrigeration leak detection system and assembly.

### BACKGROUND

Applicant desires a system and method for improved, reliable refrigeration leak detection performance without the drawbacks presented by the traditional systems and methods.

### BRIEF DESCRIPTION OF THE DRAWINGS

Embodiments of the disclosure will be better understood by a reading of the Description of Embodiments along with a review of the drawings, in which:

FIG. 1 is a schematic view of a refrigeration leak detection according to one embodiment of the disclosure, with elements removed for clarity;

FIG. 2 is a schematic view of the embodiment according to FIG. 1; and

FIG. 3 is a schematic view of a refrigeration leak detection according to one embodiment of the disclosure, with elements removed for clarity.

### SUMMARY

Applicant desires refrigeration leak detection device, system, assembly, and method of use without the drawbacks presented by the traditional systems and methods. Those skilled in the art having the benefit of this disclosure will recognize additional features, advantages over conventional systems, and improvements for leak detection, when present, and the like.

In accordance with the present inventions, Applicant's universal device and assembly provides a leak detection, including, but not limited to, a refrigeration leak detection. These inventions provide an improved hybrid assembly and system that is convenient, efficient, and safe for the user, particularly when monitoring/maintaining freezer, refrigeration, and the like performance.

In one embodiment, a refrigeration system includes a non-invasive ultrasonic flowmeter to monitor an ultrasonic signal within the refrigeration system to trigger a leak detection alert.

In one example, the leak detection alert includes an early-warning fluid leak detection alert. The system may include at least one sensor affixed about a conduit. The system may include a transmitter in communication with the sensor. The transmitter may include transmit an ultrasonic signal broadcasting circumferentially about the conduit and a fluid component broadcasting through the conduit. The non-invasive ultrasonic flowmeter may be independent of a sight glass.

In one example, the non-invasive ultrasonic flowmeter may be aligned about a conduit transporting subcooled liquid. The non-invasive ultrasonic flowmeter may be aligned about a conduit transporting a hot liquid. The non-invasive ultrasonic flowmeter may be aligned between a filter drier and an expansion valve. The refrigeration system may include a sight glass.

In one example, the system may include a user interface in electronic communication with the non-invasive ultrasonic flowmeter. The system may include a remote user interface. The system may include a remote communication to a plurality of differing remote locations. The user interface may provide sensitivity of alarm detection. The user interface may provide an adjustable timing corresponding to an alarm detection.

In one example, the system may include a refrigeration system shut-down control. The refrigeration system shut-down control may be in communication with an alarm output signal. The system may include optics in communication with an alarm output signal. The system may include a remote compressor pressure monitoring alert. The system may include a remote compressor amperage monitoring alert.

In one example, a non-invasive ultrasonic flowmeter may include a first transducer and a second transducer in a signal communication to send and receive an acoustic signal. The non-invasive ultrasonic flowmeter may include a plurality of acoustic noise attenuating elements adapted to filter out mechanical and electrical noise. The refrigeration system may include a lyophilization freeze drying assembly. The non-invasive ultrasonic flowmeter may include monitoring about a high heat liquid. The non-invasive ultrasonic flowmeter may be secured about an exterior of a conduit.

In one example, the non-invasive ultrasonic flowmeter may employ a frequency shift of an ultrasonic signal reflected by suspended particles or bubbles in motion within a conduit. The non-invasive ultrasonic flowmeter may include a Doppler ultrasonic flowmeter. The Doppler non-invasive ultrasonic flowmeter may monitor a frequency of an ultrasonic signal change in direct proportion to a rate of flow within the conduit when reflected by the suspended particles or bubbles. The system may include a transmitter, an indicator, a totalizer, and a transducer. The transmitter may include a high-frequency oscillator adapted to drive the transducer mounted adjacent a conduit. The flowmeter may include a first oscillator aligned on the conduit opposing a second oscillator. The system may include a plurality of acoustic filters aligned between the first oscillator and the second oscillator.

In one example, the flowmeter may measure a fluid flow within a predetermined portion of the conduit. The flowmeter may be positioned adjacent a hot liquid between a filter drier and an expansion valve. The system may include an evaporator downstream of the expansion valve. The system may include a low pressure liquid between the expansion valve and the evaporator. The system may include a compressor downstream of the evaporator. The system may include a low pressure gas between the evaporator and the compressor. The system may include a condenser downstream of the compressor. The system may include a high heat gas between the compressor and the condenser. The system may include a hot liquid between the condenser and the filter drier.

The system may include a receiver downstream of the condenser. The assembly may include a hot liquid between the filter drier and the expansion valve.

In one embodiment, a method of servicing a refrigeration system comprises providing an ultrasonic flowmeter aligned about the refrigeration system; non-invasively monitoring an ultrasonic signal within the refrigeration system; and triggering a leak detection, when present, alert based on the ultrasonic signal.

In one embodiment, a detection assembly comprises a refrigeration system having a filter drier and an expansion valve; a sight glass; a conduit in flow communication between at least the filter drier, the expansion valve, and the sight glass; and an ultrasonic flowmeter aligned between the filter drier and the expansion valve and adjacent the sight glass, and wherein the ultrasonic flowmeter positioned on an exterior of the conduit and in signal communication with an interior of the conduit to provide an early-warning leak detection alert.

In one example, the assembly may include a user interface in electronic communication with the ultrasonic flowmeter. The assembly may include a remote user interface. The assembly may include remote communication to a plurality of differing remote locations. The user interface may provide sensitivity of alarm detection. The user interface may provide an adjustable timing corresponding to the alarm detection. The assembly may include a refrigeration system shut-down control. The refrigeration system shut-down control may be in communication with an alarm output signal.

In one example, the assembly may include an optics system positioned about the sight glass. The optics system may be in communication with an alarm output signal. The assembly may include a remote compressor pressure monitoring system. The assembly may include a remote compressor amperage monitoring system. The ultrasonic flowmeter may include a first transducer and a second transducer in a signal communication to send and receive an acoustic signal. The ultrasonic flowmeter may include a plurality of acoustic noise attenuating elements adapted to filter out mechanical and electrical noise. The refrigeration system may include a lyophilization freeze drying assembly. The ultrasonic flowmeter may monitor about a high heat liquid.

In one example, the ultrasonic flowmeter may be secured about an exterior of the conduit. The ultrasonic flowmeter may employ a frequency shift of an ultrasonic signal reflected by suspended particles or bubbles in motion within the conduit. The ultrasonic flowmeter may include a Doppler ultrasonic flowmeter. The Doppler ultrasonic flowmeter may monitor a frequency of an ultrasonic signal change in direct proportion to a rate of flow within the conduit when reflected by the suspended particles or bubbles.

In one example, the assembly may include a transmitter, an indicator, a totalizer, and a transducer. The transmitter may include a high-frequency oscillator adapted to drive the transducer mounted adjacent the conduit. The flowmeter may include a first oscillator aligned on the conduit opposing a second oscillator. The assembly may include a plurality of acoustic filters aligned between the first oscillator and the second oscillator. The flowmeter may measure a fluid flow within a predetermined portion of the conduit. The assembly may include an evaporator downstream of the expansion valve. The assembly may include a low pressure liquid between the expansion valve and the evaporator. The assembly may include a compressor downstream of the evaporator. The assembly may include a low pressure gas between the evaporator and the compressor. The assembly may include a condenser downstream of the compressor.

In certain examples, the assembly may include a high heat gas between the compressor and the condenser. The assembly may include a hot liquid between the condenser and the filter drier. The assembly may include a receiver downstream of the condenser. The assembly may include a hot liquid between the filter drier and the expansion valve. The flowmeter may be positioned adjacent the hot liquid between the filter drier and the expansion valve. The ultrasonic flowmeter may be independent of a sight glass.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### DETAILED DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

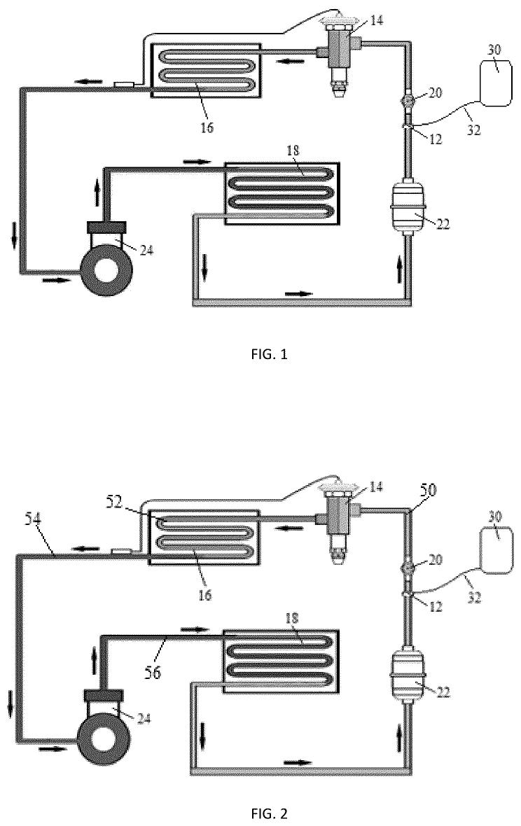

Referring now to the drawings in general and FIG. 1 in particular, it will be understood that the illustrations are for the purpose of describing embodiments of the disclosure and are not intended to limit the disclosure or any inventions thereto. As best seen in FIGS. 1-2 and 3, a non-invasive assembly 10 includes an ultrasonic flowmeter 12 to monitor an ultrasonic signal within the refrigeration system to trigger a leak detection alert, when present.

As illustrated, particular embodiments of the refrigeration system may include a filter drier 22, an expansion valve 14, an evaporator 16, a compressor 24, and a condenser 18. Any of the flowmeters shown and described herein may be positioned about a predetermined portion of an interconnecting conduit. For instance, in certain examples, the flowmeter 12 may be positioned between the filter drier 22 and the expansion valve 14, and adjacent the sight glass 20. Those skilled in the art having the benefit of this disclosure will recognize any refrigeration, freezer, and the like, system applications of the embodiments and examples herein. Related teachings include https://web.mit.edu/2.972/www/reports/compression_refrigeration_system/compression_refrigeration_system.html; https://www.swtc.edu/Ag_Power/air_conditioning/lecture/basic_cycle.htm; and https://refindustry.com/articles/articles/how-does-a-refrigeration-system-work, the teachings of which that are consistent with the embodiments and examples shown and described herein are incorporated by reference in their entireties. Further, the refrigeration system may include a lyophilization freeze drying assemble, for instance as introduced in https://www.sciencedirect.com/topics/chemistry/freeze-drying and https://en.wikipedia.org/wiki/Freeze-drying, the teachings of which that are consistent with the embodiments and examples shown and described herein are incorporated by reference in their entireties

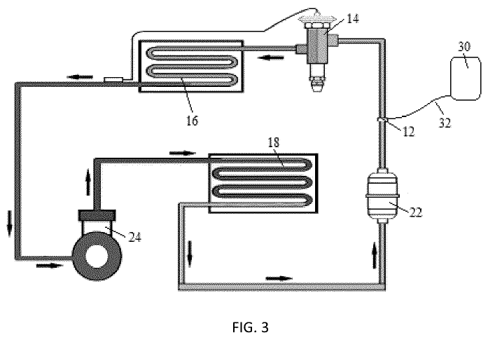

As shown in FIGS. 1 and 2, one embodiment of a detection assembly includes a refrigeration system having a filter drier 22 and an expansion valve 14; a sight glass 20; a conduit being in flow communication between at least filter drier 22, expansion valve 14, and sight glass 20. As illustrated, an ultrasonic flowmeter 12 may be aligned between filter drier 22 and expansion valve 14, for instance adjacent, or the like, the sight glass 20. Typically, the ultrasonic flowmeter 12 is positioned on an exterior of the conduit and in signal communication with an interior of conduit to provide any of the early-warning leak detection alerts shown and described herein.

In certain examples, and illustrated in FIG. 2, any refrigeration system shown and described herein may include a high heat gas 56 between the compressor 24 and the condenser 18. The refrigeration system may include a hot liquid 50 between the condenser 18 and the filter drier 14, for instance at the ultrasonic flowmeter 12 and/or sight glass 20. For instance, the refrigeration system may include a hot liquid 50 between the filter drier 22 and the expansion valve 14. Further, the refrigeration system may include a low pressure liquid 52 between the expansion valve 14 and the evaporator 16. The refrigeration system may include a low pressure gas 54 between the evaporator 16 and the compressor 24. Those skilled in the art having the benefit of this disclosure will recognize any refrigeration system, or the like, configuration and assembly.

FIG. 1-3 illustrate examples having a user interface 30 in electronic communication 32 with the ultrasonic flowmeter 12. In certain examples, the assembly may include a remote user interface, for instance to provide remote communication to one, or more, of differing remote location(s). The user interface may provide sensitivity of alarm detection, adjustable timing corresponding to the alarm detection, refrigeration system shut-down control, a combination thereof, and the like. Those skilled in the art having the benefit of this disclosure will recognize any user interface 30 application and system capability.

In certain examples, the assembly may include any optics system positioned about the sight glass to monitor any of the corresponding early-warning leak detection alerts shown and described herein. For instance, the optics system may be in communication with an alarm output signal.

In certain examples, the assembly may include any remote system activation/manipulation to correspond with any of the early-warning leak detection alerts shown and described herein. For instance, the assembly may include a remote compressor pressure monitoring system, a remote compressor amperage monitoring system, a combination thereof, and the like. Those skilled in the art having the benefit of this disclosure will recognize any system activation/manipulation.

In certain examples, any ultrasonic flowmeter 12 shown and described herein may include a Doppler ultrasonic flowmeter. The Doppler ultrasonic flowmeter may monitor a frequency of an ultrasonic signal change in direct proportion to a rate of flow within the conduit when reflected by the suspended particles or bubbles. Those skilled in the art having the benefit of this disclosure will recognize any ultrasonic signal, including doppler effect, system applications of the embodiments and examples herein. Related teachings include https://www.britannica.com/science/ultrasonics/Ranging-and-navigating; https://www.omega.com/en-us/resources/dif-between-doppler-transit-time-ultrasonic-flow-meters; and https://en.wikipedia.org/wiki/Doppler_effect, the teachings of which that are consistent with the embodiments and examples shown and described herein are incorporated by reference in their entireties.

In other embodiments, the disclosure includes a universal assembly kit, including both new equipment kits and existing equipment retrofit kits. In such an embodiment, the kit may comprise a refrigeration system, e.g. any of the refrigeration, freezer, or the like elements and components previously shown or described; and an ultrasonic flowmeter 12, e.g. any flowmeter elements and components previously shown or described.

Numerous characteristics and advantages have been set forth in the foregoing description, together with details of structure and function. Many of the novel features are pointed out in the appended example claims. The disclosure, however, is illustrative only, and changes may be made in detail, especially in matters of shape, size and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

What I claim is:

1. A detection assembly comprising:
a. a refrigeration system having a filter drier and an expansion valve;
b. a sight glass;
c. a conduit in flow communication between at least said filter drier, said expansion valve, and said sight glass; and
d. an ultrasonic flowmeter aligned between said filter drier and said expansion valve and adjacent said sight glass, and wherein said ultrasonic flowmeter positioned on an exterior of said conduit and in signal communication with an interior of said conduit and adapted to provide an early-warning leak detection alert.

2. The assembly of claim 1, including a user interface in electronic communication with said ultrasonic flowmeter.

3. The assembly of claim 2, including a remote user interface.

4. The assembly of claim 3, including remote communication to a plurality of differing remote locations.

5. The assembly of claim 2, wherein said user interface adapted to provide sensitivity of alarm detection.

6. The assembly of claim 5, wherein said user interface adapted to provide an adjustable timing corresponding to said alarm detection.

7. The assembly of claim 2, including a refrigeration system shut-down control.

8. The assembly of claim 7, wherein said refrigeration system shut-down control being in communication with an alarm output signal.

9. The assembly of claim 1, including an optics system positioned about said sight glass.

10. The assembly of claim 9, wherein said optics system in communication with an alarm output signal.

11. The assembly of claim 1, including a remote compressor pressure monitoring system.

12. The assembly of claim 1, including a remote compressor amperage monitoring system.

13. The assembly of claim 1, wherein said ultrasonic flowmeter having a first transducer and a second transducer in a signal communication to send and receive an acoustic signal.

14. The assembly of claim 1, wherein said ultrasonic flowmeter having a plurality of acoustic noise attenuating elements adapted to filter out mechanical and electrical noise.

15. The assembly of claim 1, wherein said refrigeration system comprising a lyophilization freeze drying assembly.

16. The assembly of claim 1, wherein said ultrasonic flowmeter monitoring about a high heat liquid.

17. The assembly of claim 1, wherein said ultrasonic flowmeter secured about an exterior of said conduit.

18. The assembly of claim 1, wherein said ultrasonic flowmeter employing a frequency shift of an ultrasonic signal reflected by suspended particles or bubbles in motion within said conduit.

19. The assembly of claim 1, wherein said ultrasonic flowmeter comprising a Doppler ultrasonic flowmeter.

20. The assembly of claim 1, wherein said Doppler ultrasonic flowmeter monitors a frequency of an ultrasonic signal change in direct proportion to a rate of flow within said conduit when reflected by said suspended particles or bubbles.

21. The assembly of claim 20, including a transmitter, an indicator, a totalizer, and a transducer.

22. The assembly of claim 21, wherein said transmitter includes a high-frequency oscillator adapted to drive said transducer mounted adjacent said conduit.

23. The assembly of claim 20, wherein said flowmeter includes a first oscillator aligned on said conduit opposing a second oscillator.

24. The assembly of claim 23, including a plurality of acoustic filters aligned between said first oscillator and said second oscillator.

25. The assembly of claim 1, wherein said flowmeter adapted to measure a fluid flow within a predetermined portion of said conduit.

26. The assembly of claim 1, including an evaporator downstream of said expansion valve.

27. The assembly of claim 26, including a low pressure liquid between said expansion valve and said evaporator.

28. The assembly of claim 26, including a compressor downstream of said evaporator.

29. The assembly of claim 28, including a low pressure gas between said evaporator and said compressor.

30. The assembly of claim 28, including a condenser downstream of said compressor.

31. The assembly of claim 30, including a high heat gas between said compressor and said condenser.

32. The assembly of claim 30, including a hot liquid between said condenser and said filter drier.

33. The assembly of claim 30, including a receiver downstream of said condenser.

34. The assembly of claim 30, including a hot liquid between said filter drier and said expansion valve.

35. The assembly of claim 34, wherein said flowmeter positioned adjacent said hot liquid between said filter drier and said expansion valve.

36. The assembly of claim 1, wherein said ultrasonic flowmeter being independent of a sight glass.

37. In a refrigeration system, a non-invasive ultrasonic flowmeter adapted to monitor an ultrasonic signal within said refrigeration system to trigger a leak detection alert.

38. The system of claim 37, wherein said leak detection alert being an early-warning fluid leak detection alert.

39. The system of claim 37, including at least one sensor affixed about a conduit.

40. The system of claim 39, including a transmitter in communication with said sensor.

41. The system of claim 40, wherein said transmitter adapted to transmit an ultrasonic signal broadcasting circumferentially about said conduit and a fluid component broadcasting through said conduit.

42. The system of claim 37, wherein said non-invasive ultrasonic flowmeter being independent of a sight glass.

43. The system of claim 37, wherein said non-invasive ultrasonic flowmeter aligned about a conduit transporting subcooled liquid.

44. The system of claim 37, wherein said non-invasive ultrasonic flowmeter aligned about a conduit transporting a hot liquid.

45. The system of claim 37, wherein said non-invasive ultrasonic flowmeter aligned between a filter drier and an expansion valve.

46. The system of claim 37, wherein said refrigeration system includes a sight glass.

47. The system of claim 37, including a user interface in electronic communication with said non-invasive ultrasonic flowmeter.

48. The system of claim 47, including a remote user interface.

49. The system of claim 48, including remote communication to a plurality of differing remote locations.

50. The system of claim 47, wherein said user interface adapted to provide sensitivity of alarm detection.

51. The system of claim 47, wherein said user interface adapted to provide an adjustable timing corresponding to an alarm detection.

52. The system of claim 37, including a refrigeration system shut-down control.

53. The system of claim 52, wherein said refrigeration system shut-down control in communication with an alarm output signal.

54. The system of claim 37, including optics in communication with an alarm output signal.

55. The system of claim 37, including a remote compressor pressure monitoring alert.

56. The system of claim 37, including a remote compressor amperage monitoring alert.

57. The system of claim 37, wherein said non-invasive ultrasonic flowmeter having a first transducer and a second transducer in a signal communication to send and receive an acoustic signal.

58. The system of claim 37, wherein said non-invasive ultrasonic flowmeter having a plurality of acoustic noise attenuating elements adapted to filter out mechanical and electrical noise.

59. The system of claim 37, wherein said refrigeration system comprising a lyophilization freeze drying assembly.

60. The system of claim 37, wherein said non-invasive ultrasonic flowmeter monitoring about a high heat liquid.

61. The system of claim 37, wherein said non-invasive ultrasonic flowmeter secured about an exterior of a conduit.

62. The system of claim 37, wherein said non-invasive ultrasonic flowmeter employing a frequency shift of an ultrasonic signal reflected by suspended particles or bubbles in motion within a conduit.

63. The system of claim 37, wherein said non-invasive ultrasonic flowmeter comprising a Doppler ultrasonic flowmeter.

64. The system of claim 37, wherein said Doppler non-invasive ultrasonic flowmeter monitors a frequency of an ultrasonic signal change in direct proportion to a rate of flow within said conduit when reflected by said suspended particles or bubbles.

65. The system of claim 64, including a transmitter, an indicator, a totalizer, and a transducer.

66. The system of claim 65, wherein said transmitter includes a high-frequency oscillator adapted to drive said transducer mounted adjacent a conduit.

67. The system of claim 37, wherein said flowmeter includes a first oscillator aligned on said conduit opposing a second oscillator.

68. The system of claim 67, including a plurality of acoustic filters aligned between said first oscillator and said second oscillator.

69. The system of claim 37, wherein said flowmeter adapted to measure a fluid flow within a predetermined portion of said conduit.

70. The system of claim 69, wherein said flowmeter positioned adjacent a hot liquid between a filter drier and an expansion valve.

71. The system of claim 37, including an evaporator downstream of said expansion valve.

72. The system of claim 71, including a low pressure liquid between said expansion valve and said evaporator.

73. The system of claim 71, including a compressor downstream of said evaporator.

74. The system of claim 73, including a low pressure gas between said evaporator and said compressor.

75. The assembly of claim 71, including a condenser downstream of said compressor.

76. The system of claim 75, including a high heat gas between said compressor and said condenser.

77. The system of claim 75, including a hot liquid between said condenser and said filter drier.

78. The system of claim 75, including a receiver downstream of said condenser.

79. The assembly of claim 75, including a hot liquid between said filter drier and said expansion valve.

80. A method of servicing a refrigeration system, said method comprising:
a. providing an ultrasonic flowmeter aligned about said refrigeration system;
b. non-invasively monitoring an ultrasonic signal within said refrigeration system; and
c. triggering a leak detection, when present, alert based on said ultrasonic signal.
